(19) United States
(12) Patent Application Publication
(10) Pub. No.: US 2018/0358012 A1
(43) Pub. Date: Dec. 13, 2018

(54) CHANGING INFORMATION OUTPUT MODALITIES

(71) Applicant: Intel Corporation, Santa Clara, CA (US)

(72) Inventors: Martin Henk Van Den Berg, Palo Alto, CA (US); Jose Gabriel De Amores Carredano, Sevilla, SE (ES); Maria Pilar Manchon Portillo, Los Altos, CA (US); Guillermo Perez, Sevilla (ES); Jessica M. Christian, Sunnyvale, CA (US); Rajeev Agarwal, Fremont, CA (US)

(73) Assignee: Intel Corporation, Santa Clara, CA (US)

(21) Appl. No.: 15/781,969

(22) PCT Filed: Dec. 23, 2015
(86) PCT No.: PCT/EP2015/081219

§ 371 Date: Jun. 6, 2018

(51) Int. Cl. G10L 15/22; G06F 9/451

(52) U.S. Cl. CPC G10L 15/22; G10L 2015/223; G06F 9/453

(57) ABSTRACT

Embodiments are directed to systems, methods, and devices for providing help to a user through an output modality. Embodiments include an analysis logic implemented at least partially in hardware to receive an indication to provide help or other information to the user; identify an availability of one or more output modalities for providing the help; and determine an output modality for providing the help based on the availability of the one or more output modalities. Embodiments also include a dialog system implemented at least partially in hardware to process the request for help; and provide a dialog message in response to the request for help, the dialog message provided on the determined output modality. Some embodiments also include a sensor input for receiving sensory information, wherein the analysis logic identifies the output modality based, at least in part, on the sensory information.

### TECHNICAL FIELD

This disclosure pertains to changing help modalities, and more particularly, to changing help modalities for a dialog system.

### BACKGROUND

Help messages are produced in interactive systems in response to a user request or are triggered by other events such as an automatic speech recognition (ASR) system or natural language understanding failure. While some messages cycle through a list of paraphrases to provide some variety in presentation, messages are typically invariant with respect to the modalities used to present the help message to user because they do not consider the situational context of the interaction. In addition to the potential for being repetitive, this type of message can be less useful, or even inaccessible to the user.

### BRIEF DESCRIPTION OF THE DRAWINGS

FIG. 1 is a schematic block diagram of a system for changing help modalities in accordance with embodiments of the present disclosure.

FIG. 2 is a schematic block diagram of a dialog system for changing help modalities in accordance with embodiments of the present disclosure.

FIG. 3 is a process flow diagram for changing help modalities in accordance with embodiments of the present disclosure.

FIG. 4 is an example illustration of a processor according to an embodiment of the present disclosure.

FIG. 5 is a schematic block diagram of a mobile device in accordance with embodiments of the present disclosure.

FIG. 6 is a schematic block diagram of a computing system according to an embodiment of the present disclosure.

### DETAILED DESCRIPTION

This disclosure describes providing a user with help or information based on an indication of a request for help or for information. If a user asks for information or needs help, the system provides the help or information through an output modality tailored to the format of the information or help, the way the user is able to take in the information, the available output modalities (i.e., available to the user and/or available to the system through some connectivity).

In the context of biometric and other sensors, help information is informed by the physical context of the user the system is interacting with, including the way the user is interacting with the system. The system will dynamically adjust to the user's needs and device accessibility and sound less repetitive and irrelevant, thereby being more helpful.

To illustrate different ways the system can adjust help based on the circumstances, the following example flow is provided:

(1) Depending on how the user is currently able to take in information, the output modality of the requested information can be adjusted. If the user has access to a screen, visual information can accompany verbal forms of the requested help. If there is no screen, more extensive verbal information may be given. Other mixed modalities could lead to other forms, like flashing lights to accompany rhythmic or directional information etc.

2) After answering the question, and the user starts to apply the techniques learned, the system may notice that the user is not doing it correctly, and offer additional help to assist in achieving the requested information.

(3) If the system knows which modalities are available, it may offer a different one if more suitable. For example, suppose the user is not looking at a phone that includes the system, the system may use speech synthesis to provide audible speech to provide the information. If the user then says that he or she does not understand, or the system notices that the user is not following the directions correctly (2 above), the system may suggest taking out the phone and looking at the diagram for more precise instructions.

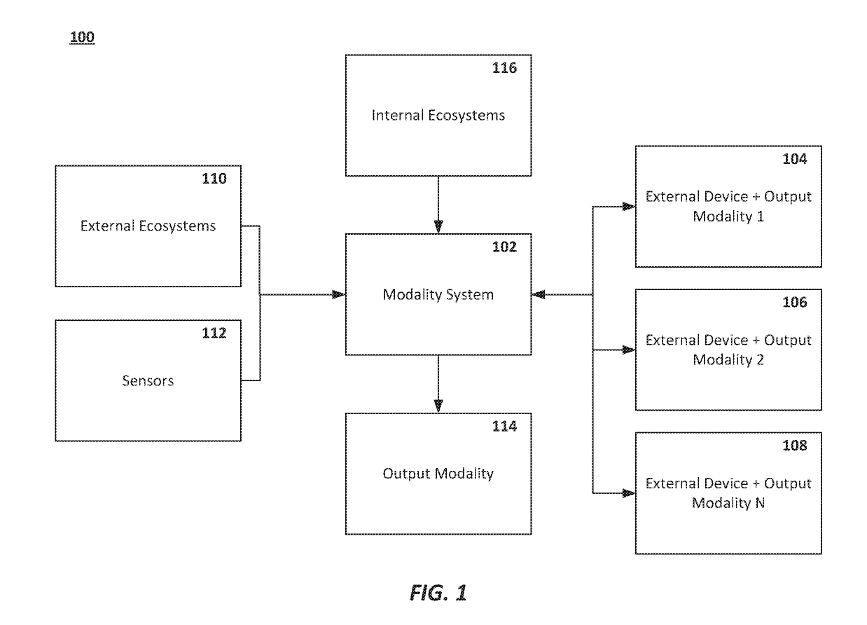

FIG. 1 is a schematic block diagram of a modality system 200 for changing help modalities in accordance with embodiments of the present disclosure. FIG. 1 shows a high level modality system 200 that includes a modality system 102. The modality system 102 can be integrated into or be in communication with in smartphones, tablet computers, desktops, laptops, wearable devices. The system may also be used in automotive applications, fitness and health applications, home-automation, shop assistants, and other multi-modal dialog situations.

The modality system 102 can include or can communicate with one or more output modalities. The output modality 114 can be integrated into the modality system 102. For example, the modality system 102 can include a speaker, a headphone connection, a display, a vibration system, etc. In some embodiments, the modality system 102 can be connected to one or more external devices 104, 106, and/or 108. Taking external device 104 as an example, modality system 102 can be connected to or in communication with the external device 104 by a wireless connection, such as by a Bluetooth connection, Wifi connection, wireless local area network (e.g., directly or through a hub or controller), radio frequency connection, cellular connection, etc. The modality system 102 can also be in communication with the externa device 104 through a wired connections, such as a universal serial bus (USB) connection, headphone jack, proprietary cable connection, docking station, etc. The connection allows the modality system 102 to 1) recognize the availability of output modalities associated with each external device and 2) cause the output modality on the external device to provide the information to the user. The modality system 102 can include one or more application programming interfaces (API) that allow the modality system 102 to communicate with the external device 104.

The modality system 102 can also receive information from one or more sensors 216. Sensor 216 can include biometric sensors, inertial sensors, global positioning systems (GPS), sound sensors, etc. Example biometric sensors a heartbeat sensor, pulse oximeter, EEG, sweat sensor, breath rate sensor, pedometer, blood pressure sensor, etc. Sound sensors can include microphones or other sound sensors. Inertial sensors can include gyroscopes, accelerometers, etc.

The modality system 102 can also receive information from external ecosystems 110. External ecosystems 110 can include any number of sources of information, such as the Internet to provide information or background noise to inform the modality system 102 about the best output modality to provide information to the user.

The modality system 102 can also receive information from internal ecosystems 116, such as calendar events, applications running on the device, listing of available Bluetooth devices, device power level, etc. The information in internal ecosystem 116 can also be provided by external ecosystems 110 through wireless or wireline connectivity.

Modality system 102 can also include one or more output modalities 114 integrated within itself. The modality system 102 can use an integrated output modality 114 or can use an external output modality on an external device 104 if available.

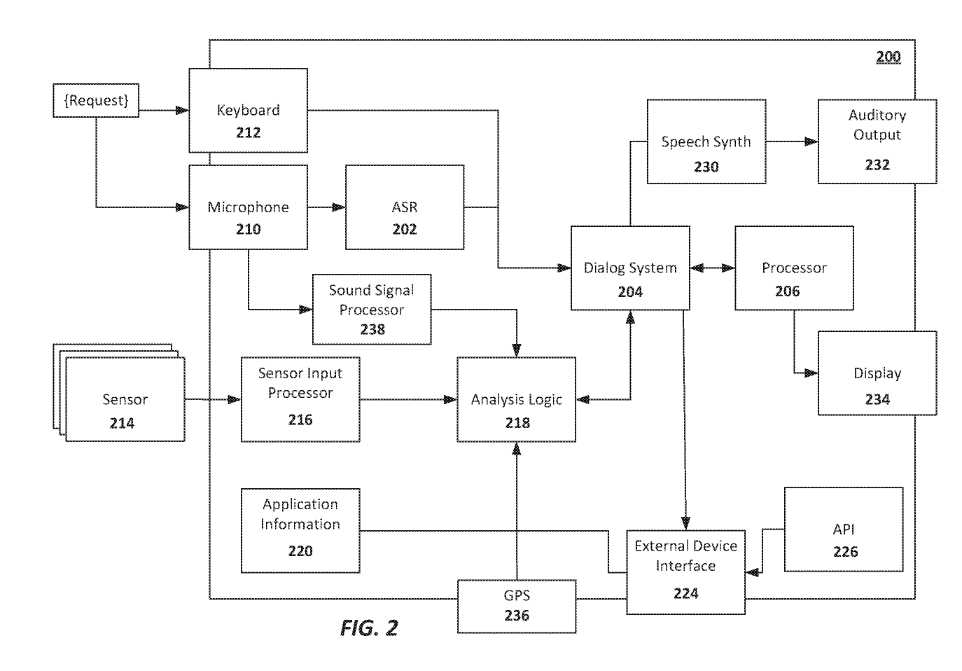

FIG. 2 is a schematic block diagram of a modality system 200 for changing help modalities in accordance with embodiments of the present disclosure. Modality system 200 can include some or all of the features described above for modality modality system 200 in connection with FIG. 1. Modality system 200 can include a dialog system 204 implemented in hardware, software, or a combination of hardware and software. The modality system 200 also includes one or more inputs, such as microphone 21 and/or text input 212 (e.g., keyboard 212), and can also include a gestures input or inertial input, such as a movement of a device. The one or more inputs are configured to receive requests for information or help from a user through one or more input modalities, such as audible speech or text.

Generally, the dialog system 204 can receive textual inputs from the automatic speech recognition (ASR) system 202 to interpret the speech input and provide an appropriate response, in the form of an executed command, a verbal response (oral or textual), or some combination of the two.

The modality system 200 also includes a processor 206 for executing instructions from the dialog system 204. The modality system 200 can also include a speech synthesizer 230 that can synthesize a voice output. Modality system 200 can include an auditory output 232 that outputs audible sounds, including synthesized voice sounds, via a speaker or headphones or Bluetooth connected device, etc. The modality system 200 also includes a display 234 that can display textual information and images and video as a response to an instruction or inquiry, or for other reasons.

The modality system 200 may include one or more sensors 214 that can provide a signal into a sensor input processor 216. The sensor 214 can be part of the modality system 200 or can be part of a separate, external device, such as a wearable device. The sensor 214 can communicate with the modality system 200 via Bluetooth, Wifi, wireline, WLAN, etc. Though shown as a single sensor 214, more than one sensor can supply signals to the sensor input processor 216. The sensor 214 can include any type of sensor that can provide external information to the modality system 200. For example, sensor 214 can include a biometric sensor, such as a heartbeat sensor. Others examples include a pulse oximeter, EEG, sweat sensor, breath rate sensor, pedometer, blood pressure sensor, etc. Other examples of biometric information can include heart rate, stride rate, cadence, breath rate, vocal fry, breathy phonation, amount of sweat, etc. In some embodiments, the sensor 214 can include an inertial sensor to detect vibrations of the user, such as whether the users hands are shaking, etc.

The sensor 214 can provide electrical signals representing sensor data to the sensor input processor 216, which can be implemented in hardware, software, or a combination of hardware and software. The sensor input processor 216 receives electrical signals representing sensory information. The sensor input processor 216 can turn the electrical signals into contextually relevant information. For example, the sensor input processor 216 can translate an electrical signal representing a certain heart rate into formatted information, such as beats/minute. For a inertial sensor, the sensor input processor 216 can translate electrical signals representing movement into how much a user's hand is shaking. For a pedometer, the sensor input processor 216 can translate an electrical signal representing steps into steps/minute. Other examples are readily apparent.

The sensor 214 can provide sensor signals to a sensor input processor 216. The sensor input processor 216 processes the sensor input to translate that sensor information into a format that is readable by the analysis logic 218 implemented at least partially in hardware. Sensor input processor 216 is implemented in hardware, software, or a combination of hardware and software. The analysis logic 218 can also receive a noise level from sound signal processor 238.

The modality system 200 can also include a microphone 210 for converting audible sound into corresponding electrical sound signals. The sound signals are provided to the automatic speech recognition (ASR) system 202. The ASR system 202 that can be implemented in hardware, software, or a combination of hardware and software. The ASR system 202 can be communicably coupled to and receive input from a microphone 210. The ASR system 202 can output recognized text in a textual format to a dialog system 204 implemented in hardware, software, or a combination of hardware or software.

In some embodiments, modality system 200 also includes a global positioning system (GPS) 236 configured to provide location information to modality system 200. In some embodiments, the GPS 236 can input location information into the dialog system 204 so that the dialog system 204 can use the location information for contextual interpretation of speech text received from the ASR system 202.

Generally, the dialog system 204 can receive textual inputs from the ASR system 202 to interpret the speech input and provide an appropriate response, in the form of an executed command, a verbal response (oral or textual), or some combination of the two. The modality system 200 also includes a processor 206 for executing instructions from the dialog system 204. The modality system 200 can also include a speech synthesizer 230 that can synthesize a voice output from the textual speech. Modality system 200 can include an auditory output 232 that outputs audible sounds, including synthesized voice sounds, via a speaker or headphones or Bluetooth connected device, etc. The modality system 200 also includes a display 234 that can display textual information and images as part of a dialog, as a response to an instruction or inquiry, or for other reasons.

As mentioned previously, the microphone 210 can receive audible speech input and convert the audible speech input into an electronic speech signal (referred to as a speech signal). The electronic speech signal can be provided to the ASR system 202. The ASR system 202 uses linguistic models to convert the electronic speech signal into a text format of words, such as a sentence or sentence fragment representing a user's request or instruction to the modality system 200.

The microphone 210 can also receive audible background noise. Audible background noise can be received at the same time as the audible speech input or can be received upon request by the dialog modality system 200 independent of the audible speech input. The microphone 210 can convert the audible background noise into an electrical signal representative of the audible background noise (referred to as a noise signal).

Sound signal processor 238 can be implemented in hardware, software, or a combination of hardware and software. Sound signal processor 238 can receive a sound signal that includes background noise from the microphone and determine a noise level or signal to noise ratio from the sound signal. The sound signal processor 238 can then provide the noise level or SNR to the analysis logic 218.

The noise signal can be processed by a sound signal processor 238 implemented in hardware, software, or a combination of hardware and software. The sound signal processor 238 can be part of the ASR system 202 or can be a separate hardware and/or software module. In some embodiments, a single signal that includes both the speech signal and the noise signal are provided to the sound signal processor 238. The sound signal processor 238 can determines a signal to noise ratio (SNR) of the speech signal to the noise signal. The SNR represents a level of background noise that may be interfering with the audible speech input. In some embodiments, the sound signal processor 238 can determine a noise level of the background noise.

Additionally, the sound signal processor 238 can be configured to determine information about the speaker based on the rhythm of the speech, spacing between words, sentence structure, diction, volume, pitch, breathing sounds, slurring, etc. The sound signal processor 238 can qualify these data and suggest a state of the user to the analysis logic 218. Additionally, the information about the user can also be provided to the ASR 202, which can use the state information about the user to select a linguistic model for recognizing speech.

The analysis logic 218 can be implemented in hardware, software, or a combination of hardware and software. The analysis logic 218 can make use of a processor, machine learning tools, relational tables, semantic information, stored data, metadata, and received information, such as sensory information, location information, device connectivity information, application information, etc., to make decisions about the state of the user and a preferred output modality for providing the information to the user.

The analysis logic 218 can receive inputs from the sensor input processor 216 and the sound signal processor 238 as well as other sources to make a determination as to the state of the user. The state of the user can include information pertaining to what the user is doing, where the user is, whether the user can receive audible messages or graphical messages, or other information that allows the modality system 200 to relay information to the user in an effective way. The analysis logic 218 uses one or more sensor information to make a conclusion about the state of the user. For example, the analysis logic 218 can use a heart rate of the user to conclude that the user is exercising. In some embodiments, more than one sensor information can be used to increase the accuracy of the analysis logic 218. For example, a heart rate of the user and a pedometer signal can be used to conclude that the user is walking or running. The GPS 236 can also be used to help the analysis logic 218 that the user is running in a hilly area. So, the more sensory input, the greater the potential for making an accurate conclusion as to the state of the user.

The analysis logic 218 can also use application information 220 to infer the state of the user. Application information 220 can include information from internal or external ecosystems, such as the applications that are running on the device, calendar events (e.g., calendar entries that provide information about user activity or schedule), power level of the device (low power so do not use a display, etc.), available Bluetooth connections (e.g., from a list of previously paired devices that are in range), etc.

The analysis logic 218 can also receive information from an external device interface 224. External device interface 224 can be implemented in hardware, software, or a combination of hardware and software. The external device interface 224 is configured to provide communications between the modality system 200 and one or more external devices. The external device interface 224 allows the dialog system 204 (or the processor 206) to cause the external device to provide the response to the user's request for information on an output modality identified by the analysis logic 218. Additionally, the external device interface 224 can provide information about connected devices to the analysis logic 218. The analysis logic 218 can use information about external devices to determine a set of available output modalities for providing a response to the request for information. For example, the external device can be a connected television or a smartphone with a display or a car that has output modalities, such as lights or a voice synthesizer or a display screen.

The analysis logic 218 can conclude the state of the user and one or more available output modes that are available to the user and appropriate in view of the user's state. The analysis logic 218 can provide that information to the dialog system 204. For example, if the user is running, the user is unlikely to be looking at an integrated screen. So, the instruction to the dialog system 204 can be to forgo graphical output on a display 234 in favor of an audible output 232 via speakers or headphones or connected device (e.g., Bluetooth speakers, headphones, etc.).

The dialog system 204 can identify an appropriate response to the request for help or for information. The dialog system 204 can use the user's state information received from the analysis logic 218 and the preferred modality information from the analysis logic 218 to identify a response to the request. The response can be a synthesized voice reply through speech synthesizer 230 and auditory output 232, or a text reply on the display. In some cases, the dialog system 204 can launch a webpage or a video on display 234. The dialog system 204 can also instruct that one of the connected device launch the webpage or video or provide the synthesized response or text response. The dialog system 204 can interface with the API 226 specific to the external device associated with the preferred output modality to provide the requisite data, data structures, information coding, syntax, etc. to cause the connected device to provide the response to the request for information.

In some embodiments, the analysis logic 218 can use the identified response to the user request for information to identify a preferred output modality. For example, if the response could be a video, then the analysis logic 218 can select an display modality as the preferred output modality.

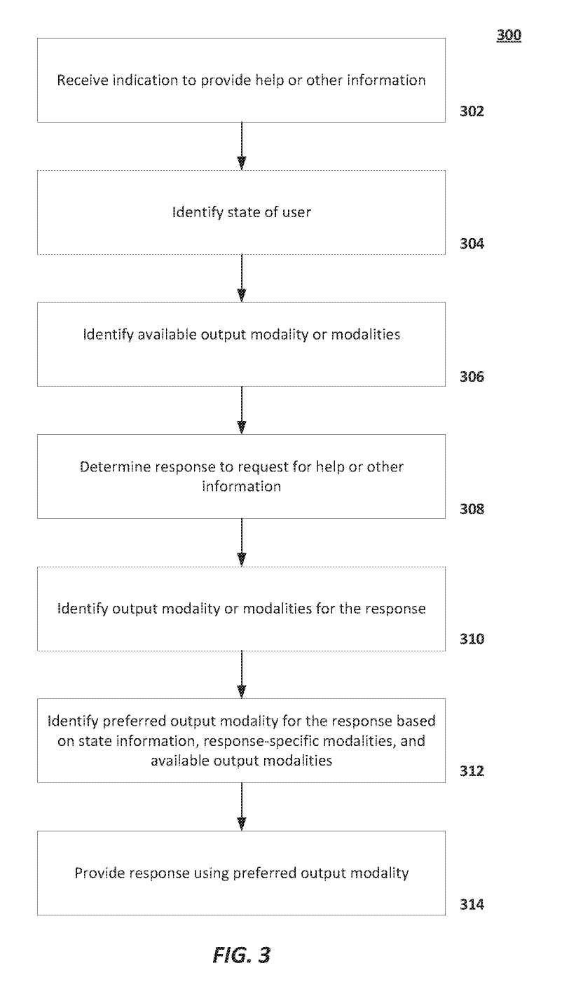

FIG. 3 is a process flow diagram 300 for changing help modalities in accordance with embodiments of the present disclosure. The order of the processes is shown for illustrative purposes, but it is understood the shown order of operations is not required. An indication can be received that causes the system to provide the user with help or information (302). The indication can be an explicit request for information or for help received from the user. The indication can also come from other indications, such as activity the user is performing or biometric information or calendar information, etc. The state of the user can be determined (304). For example, the state of the user can be determined using sensory information, application information, as well as other information. The state of the user includes what the user is doing, how the user is feeling, biometric characterizations, how the user is able to receive information and/or help, etc.

The available output modality or modalities can be identified (306). For example, one or more output modalities that are available in general for the user and for the device are identified based on connectivity information and internal systems.

An appropriate response for the request for information can be determined using a dialog system (308). The output modality for the response can be identified (310). For example, if the user is requesting driving directions, the output modality can be a list of waypoints on a device display or car navigation screen, an audible turn-by-turn instructions through device speakers or car speakers, a map displayed on a display, etc.

The preferred output modality can be identified based, at least in part, on 1) the state of the user, 2) the available output modalities, and/or 3) the output modalities appropriate for the response to the request for information (312). The response to the request for information can be provided to the user on the preferred output modality (314).

In some embodiments, the output modality can be selected based on the identified response to the request for information; in some embodiments, the response to the request for information can be determined based on the available modalities.

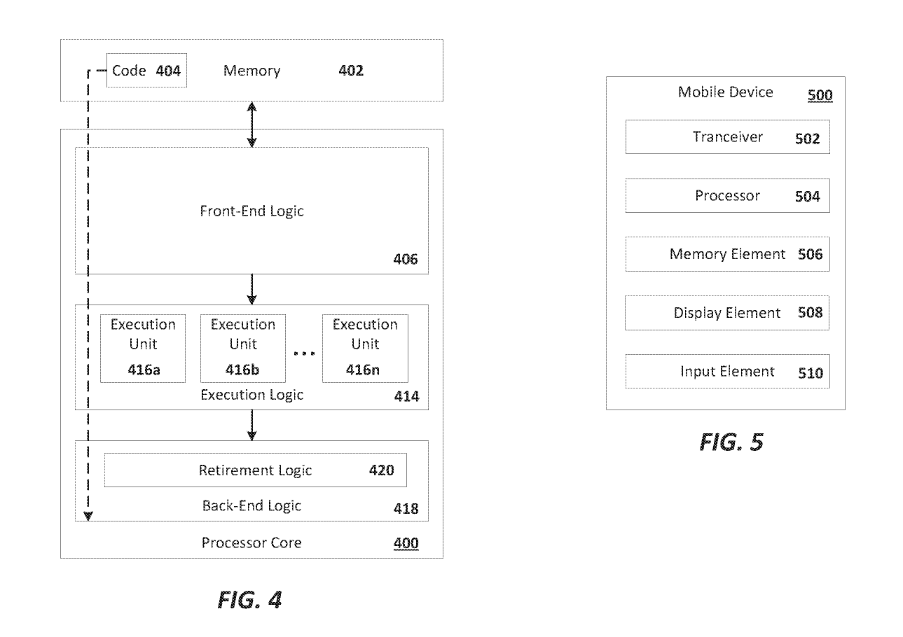

FIGS. 4-6 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 4-6.

FIG. 4 is an example illustration of a processor according to an embodiment. Processor 400 is an example of a type of hardware device that can be used in connection with the implementations above.

Processor 400 may be any type of processor, such as a microprocessor, an embedded processor, a digital signal processor (DSP), a network processor, a multi-core processor, a single core processor, or other device to execute code. Although only one processor 400 is illustrated in FIG. 4, a processing element may alternatively include more than one of processor 400 illustrated in FIG. 4. Processor 400 may be a single-threaded core or, for at least one embodiment, the processor 400 may be multi-threaded in that it may include more than one hardware thread context (or “logical processor”) per core.

FIG. 4 also illustrates a memory 402 coupled to processor 400 in accordance with an embodiment. Memory 402 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 400 can execute any type of instructions associated with algorithms, processes, or operations detailed herein. Generally, processor 400 can transform an element or an article (e.g., data) from one state or thing to another state or thing.

Code 404, which may be one or more instructions to be executed by processor 400, may be stored in memory 402, or may be stored in software, hardware, firmware, or any suitable combination thereof, or in any other internal or external component, device, element, or object where appropriate and based on particular needs. In one example, processor 400 can follow a program sequence of instructions indicated by code 404. Each instruction enters a front-end logic 406 and is processed by one or more decoders 408. The decoder may generate, as its output, a micro operation such as a fixed width micro operation in a predefined format, or may generate other instructions, microinstructions, or control signals that reflect the original code instruction. Front-end logic 406 also includes register renaming logic 410 and scheduling logic 412, which generally allocate resources and queue the operation corresponding to the instruction for execution.

Processor 400 can also include execution logic 414 having a set of execution units 416a, 416b, 416n, etc. Some embodiments may include a number of execution units dedicated to specific functions or sets of functions. Other embodiments may include only one execution unit or one execution unit that can perform a particular function. Execution logic 414 performs the operations specified by code instructions.

After completion of execution of the operations specified by the code instructions, back-end logic 418 can retire the instructions of code 404. In one embodiment, processor 400 allows out of order execution but requires in order retirement of instructions. Retirement logic 420 may take a variety of known forms (e.g., re-order buffers or the like). In this manner, processor 400 is transformed during execution of code 404, at least in terms of the output generated by the decoder, hardware registers and tables utilized by register renaming logic 410, and any registers (not shown) modified by execution logic 414.

Although not shown in FIG. 4, a processing element may include other elements on a chip with processor 400. For example, a processing element may include memory control logic along with processor 400. The processing element may include I/O control logic and/or may include I/O control logic integrated with memory control logic. The processing element may also include one or more caches. In some embodiments, non-volatile memory (such as flash memory or fuses) may also be included on the chip with processor 400.

Referring now to FIG. 5, a block diagram is illustrated of an example mobile device 500. Mobile device 500 is an example of a possible computing system (e.g., a host or endpoint device) of the examples and implementations described herein. In an embodiment, mobile device 500 operates as a transmitter and a receiver of wireless communications signals. Specifically, in one example, mobile device 500 may be capable of both transmitting and receiving cellular network voice and data mobile services. Mobile services include such functionality as full Internet access, downloadable and streaming video content, as well as voice telephone communications.

Mobile device 500 may correspond to a conventional wireless or cellular portable telephone, such as a handset that is capable of receiving “3 G”, or “third generation” cellular services. In another example, mobile device 500 may be capable of transmitting and receiving “4G” mobile services as well, or any other mobile service.

Examples of devices that can correspond to mobile device 500 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 500 illustrated in FIG. 5 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 500 includes a transceiver 502, which is connected to and in communication with an antenna. Transceiver 502 may be a radio frequency transceiver. Also, wireless signals may be transmitted and received via transceiver 502. Transceiver 502 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 502 is connected to a processor 504, which may perform the bulk of the digital signal processing of signals to be communicated and signals received, at the baseband frequency. Processor 504 can provide a graphics interface to a display element 508, for the display of text, graphics, and video to a user, as well as an input element 510 for accepting inputs from users, such as a touchpad, keypad, roller mouse, and other examples. Processor 504 may include an embodiment such as shown and described with reference to processor 400 of FIG. 4.

In an aspect of this disclosure, processor 504 may be a processor that can execute any type of instructions to achieve the functionality and operations as detailed herein. Processor 504 may also be coupled to a memory element 506 for storing information and data used in operations performed using the processor 504. Additional details of an example processor 504 and memory element 506 are subsequently described herein. In an example embodiment, mobile device 500 may be designed with a system-on-a-chip (SoC) architecture, which integrates many or all components of the mobile device into a single chip, in at least some embodiments.

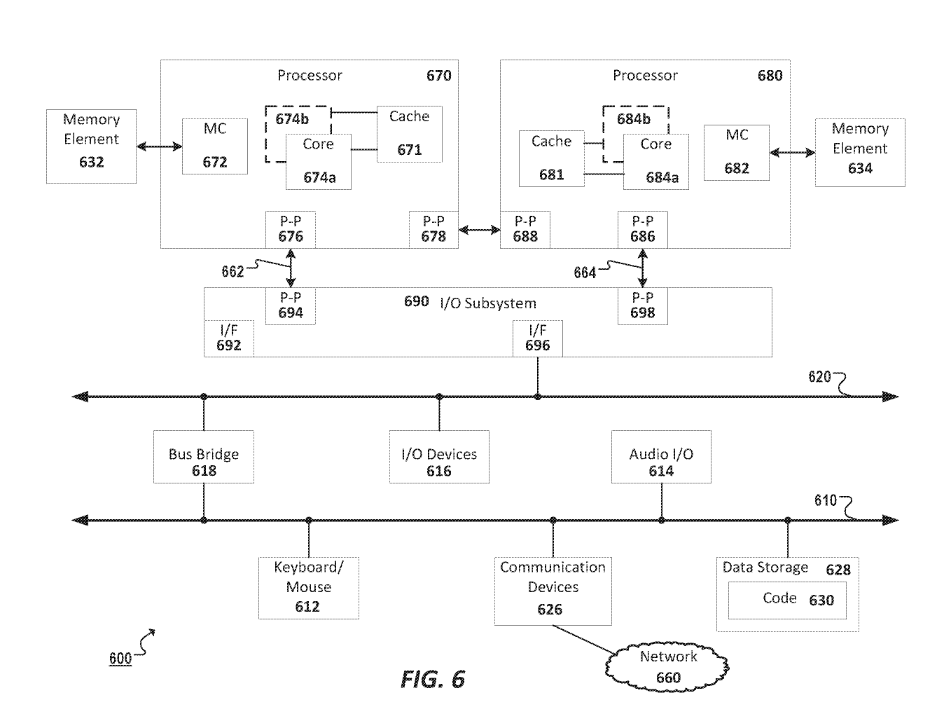

FIG. 6 is a schematic block diagram of a computing system 600 according to an embodiment. In particular, FIG. 6 shows a system where processors, memory, and input/output devices are interconnected by a number of point-to-point interfaces. Generally, one or more of the computing systems described herein may be configured in the same or similar manner as computing system 600. Elements of the present disclosure may be implemented in hardware, software, or a combination of hardware and software. To the extent that an element is implemented at least partially in hardware, the element may include software that is executed on hardware components, such as those included in the computing system 600.

Processors 670 and 680 may also each include integrated memory controller logic (MC) 672 and 682 to communicate with memory elements 632 and 634. In alternative embodiments, memory controller logic 672 and 682 may be discrete logic separate from processors 670 and 680. Memory elements 632 and/or 634 may store various data to be used by processors 670 and 680 in achieving operations and functionality outlined herein.

Processors 670 and 680 may be any type of processor, such as those discussed in connection with other figures. Processors 670 and 680 may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit via a high-performance graphics interface, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration capable of achieving the functionality and features of examples and implementations provided herein.

Example 1 is device for providing help to a user through an output modality, the device comprising an analysis logic implemented at least partially in hardware to receive an indication to provide the user with help or other information; identify an availability of one or more output modalities for providing the help; and determine an output modality for providing the help based on the availability of the one or more output modalities. Example 1 may also include a dialog system implemented at least partially in hardware to process the request for help; and provide a dialog message in response to the request for help, the dialog message provided on the determined output modality.

Example 2 may include the subject matter of example 1, further comprising a sensor input for receiving sensory information, wherein the analysis logic identifies the output modality based, at least in part, on the sensory information.

Example 3 may include the subject matter of any of examples 1 or 2, further comprising an interface to a second device, and wherein the analysis logic identifies the availability of one or more output modalities based on the connection to a second device, wherein the second device comprises one or more output modalities absent from the device.

Example 4 may include the subject matter of example 3, wherein the connection to the second device comprises one of a wireless connection or a wired connection to the second device.

Example 5 may include the subject matter of example 4, wherein the wireless connection comprises one of a Bluetooth connection, a Wifi connection, wireless local area network connection, a cellular connection, or a radio frequency connection.

Example 6 may include the subject matter of example 4, wherein the wired connection comprises one of a universal serial bus (USB) connection, a headphone jack connection, a proprietary wire connection, or a power connection.

Example 7 may include the subject matter of example 3, further comprising an application programming interface (API), the API configured to communicate through the interface with the second device, and wherein the dialog system is configured to provide a response to the request for help through the second device through the interface.

Example 8 may include the subject matter of any of examples 1 or 2, further comprising a connection to a network, and wherein the analysis logic identifies the availability of one or more output modalities based on the connection to the network.

Example 9 may include the subject matter of example 8, wherein the connection to the network comprises a connection to a home network, the home network comprises one or more connected device.

Example 10 may include the subject matter of any of examples 1-9, wherein the output modality comprises one or more of an audible sound, an audible speech, a text message, a graphical message, a video, displayed information, a vibration, an optical signal, activation of a device, or execution of a command.

Example 11 may include the subject matter of example 2, wherein the sensor input is configured to receive sensory information from one or more sensors, the one or more sensors comprising a biometric sensor, an inertial sensor, a global positioning system, or a microphone.

Example 12 may include the subject matter of any of examples 1-11, wherein the request for help is received through a text interface.

Example 13 may include the subject matter of any of examples 1-12, further comprising an automatic speech recognition (ASR) system, the ASR system configured to receive a speech signal representing an audible request for help from the user and translate the speech signal into a text format recognizable by the dialog system.

Example 14 is a method for providing information to a user, the method comprising receiving, at a user device implemented at least partially in hardware, a request for information from the user; determining a response to the request for information; identifying one or more output modalities for the response; identifying one or more available output modalities; identifying a preferred output modality for the response and from the one or more available output modalities; and providing the response to the user using the preferred output modality.

Example 15 may include the subject matter of example 14, further comprising receiving sensory information from one or more sensors identifying a state of the user based on the sensory information.

Example 16 may include the subject matter of example 15, wherein the sensory information comprises one or more of biometric information, positioning information, network connectivity information, peripheral device connectivity information, inertial information, or sound information.

Example 17 may include the subject matter of example 14, wherein identifying the availability of one or more output modalities comprises identifying a connection to a second device, wherein the second device comprises one or more output modalities absent from the user device.

Example 18 may include the subject matter of example 17, wherein the connection to the second device comprises one of a wireless connection or a wired connection to another device.

Example 19 may include the subject matter of example 18, wherein the wireless connection comprises one of a Bluetooth connection, a Wifi connection, wireless local area network connection, a cellular connection, or a radio frequency connection.

Example 20 may include the subject matter of example 18, wherein the wired connection comprises one of a universal serial bus (USB) connection, a headphone jack connection, a proprietary wire connection, or a power connection.

Example 21 may include the subject matter of example 17, wherein providing the response to the user using the preferred output modality comprises communicating with the second device through an application programming interface (API).

Example 22 may include the subject matter of any of examples 14 or 15, further comprising detecting a connection to a network, and identifying the availability of one or more output modalities comprises detecting a connection to the network, identifying a second device connected to the network, connecting to the second device through the network using an application programming interface, identifying one or more available output modalities associated with the second device; and causing the second device to provide the requested information using one or more output.

Example 23 may include the subject matter of example 22, wherein the connection to the network comprises a connection to a home network, the home network comprises one or more connected device.

Example 24 may include the subject matter of any of examples 14-23, wherein the one or more output modalities comprise one or more of an audible sound, an audible speech, a text message, a graphical message, a video, displayed information, a vibration, an optical signal, activation of a device, or execution of a command.

Example 25 may include the subject matter of example 15, further comprising receiving sensory information from one or more sensors, the one or more sensors comprising a biometric sensor, an inertial sensor, a global positioning system, or a microphone.

Example 26 may include the subject matter of any of examples 14-25, further comprising receiving the request for information by one of a text input or an audible input.

Example 27 is a computer program product tangibly embodied on non-transient computer readable media, the computer program product comprising instructions operable when executed to receive a request for help from the user; identify an availability of one or more output modalities for providing the help; determine an output modality for providing the help based on the availability of the one or more output modalities; process the request for help; and provide a dialog message in response to the request for help, the dialog message provided on the determined output modality.

Example 28 may include the subject matter of example 27, the instructions operable to receive sensory information from one or more sensors identifying a state of the user based on the sensory information.

Example 29 may include the subject matter of example 28, wherein the sensory information comprises one or more of biometric information, positioning information, network connectivity information, peripheral device connectivity information, inertial information, or sound information.

Example 30 may include the subject matter of example 27, wherein identifying the availability of one or more output modalities comprises identifying a connection to a second device, wherein the second device comprises one or more output modalities absent from the user device.

Example 31 may include the subject matter of example 30, wherein the connection to the second device comprises one of a wireless connection or a wired connection to another device.

Example 32 may include the subject matter of example 31, wherein the wireless connection comprises one of a Bluetooth connection, a Wifi connection, wireless local area network connection, a cellular connection, or a radio frequency connection.

Example 33 may include the subject matter of example 31, wherein the wired connection comprises one of a universal serial bus (USB) connection, a headphone jack connection, a proprietary wire connection, or a power connection.

Example 34 may include the subject matter of example 30, wherein providing the response to the user using the preferred output modality comprises communicating with the second device through an application programming interface (API).

Example 35 may include the subject matter of any of examples 27 or 28, the instructions operable to detect a connection to a network, and identifying the availability of one or more output modalities comprises detecting a connection to the network, identifying a second device connected to the network, connecting to the second device through the network using an application programming interface, identifying one or more available output modalities associated with the second device; and causing the second device to provide the requested information using one or more output.

Example 36 may include the subject matter of example 22, wherein the connection to the network comprises a connection to a home network, the home network comprises one or more connected device.

Example 37 may include the subject matter of any of examples 27-36, wherein the one or more output modalities comprise one or more of an audible sound, an audible speech, a text message, a graphical message, a video, displayed information, a vibration, an optical signal, activation of a device, or execution of a command.

Example 38 may include the subject matter of example 27, the instructions operable to receive sensory information from one or more sensors, the one or more sensors comprising a biometric sensor, an inertial sensor, a global positioning system, or a microphone.

Example 39 may include the subject matter of any of examples 27-38, the instructions operable to receive the request for information by one of a text input or an audible input

Example 40 is a system for providing information to a user, the system comprising a memory for storing instructions; an analysis logic implemented at least partially in hardware to receive a request for help from the user; identify an availability of one or more output modalities for providing the help; and determine an output modality for providing the help based on the availability of the one or more output modalities. The system also includes a dialog system implemented at least partially in hardware to process the request for help; and provide a dialog message in response to the request for help, the dialog message provided on the determined output modality. The system also includes a sensor input for receiving sensory information, wherein the analysis logic identifies the output modality based, at least in part, on the sensory information.

Example 41 may include the subject matter of example 40, further comprising an interface to a second device, and wherein the analysis logic identifies the availability of one or more output modalities based on the connection to a second device, wherein the second device comprises one or more output modalities absent from the device.

Example 42 may include the subject matter of example 41, wherein the connection to the second device comprises one of a wireless connection or a wired connection to the second device.

Example 43 may include the subject matter of example 42, wherein the wireless connection comprises one of a Bluetooth connection, a Wifi connection, wireless local area network connection, a cellular connection, or a radio frequency connection.

Example 44 may include the subject matter of example 42, wherein the wired connection comprises one of a universal serial bus (USB) connection, a headphone jack connection, a proprietary wire connection, or a power connection.

Example 45 may include the subject matter of example 41, further comprising an application programming interface (API), the API configured to communicate through the interface with the second device, and wherein the dialog system is configured to provide a response to the request for help through the second device through the interface.

Example 46 may include the subject matter of any of examples 40 or 41, further comprising a connection to a network, and wherein the analysis logic identifies the availability of one or more output modalities based on the connection to the network.

Example 47 may include the subject matter of example 46, wherein the connection to the network comprises a connection to a home network, the home network comprises one or more connected device.

Example 48 may include the subject matter of any of examples 40-47, wherein the output modality comprises one or more of an audible sound, an audible speech, a text message, a graphical message, a video, displayed information, a vibration, an optical signal, activation of a device, or execution of a command.

Example 49 may include the subject matter of example 40, wherein the sensor input is configured to receive sensory information from one or more sensors, the one or more sensors comprising a biometric sensor, an inertial sensor, a global positioning system, or a microphone.

Example 50 may include the subject matter of any of examples 50-49, wherein the request for help is received through a text interface.

Example 51 may include the subject matter of any of examples 40-50, further comprising an automatic speech recognition (ASR) system, the ASR system configured to receive a speech signal representing an audible request for help from the user and translate the speech signal into a text format recognizable by the dialog system.

While this specification contains many specific implementation details, these should not be construed as limitations on the scope of any disclosures or of what may be claimed, but rather as descriptions of features specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A device for providing help to a user through an output modality, the device comprising:
an analysis logic implemented at least partially in hardware to:
receive an indication to provide help to the user;
identify an availability of one or more output modalities for providing the help; and
determine an output modality for providing the help based on the availability of the one or more output modalities; and
a dialog system implemented at least partially in hardware to:
process the request for help; and
provide a dialog message in response to the request for help, the dialog message provided on the determined output modality.

2. The device of claim 1, further comprising a sensor input for receiving sensory information, wherein the analysis logic identifies the output modality based, at least in part, on the sensory information.

3. The device of claim 1, further comprising an interface to a second device, and wherein the analysis logic identifies the availability of one or more output modalities based on a connection to a second device, wherein the second device comprises one or more output modalities absent from the device.

4. The device of claim 3, wherein the connection to the second device comprises one of a wireless connection or a wired connection to the second device.

5. The device of claim 1, further comprising a connection to a network, and wherein the analysis logic identifies the availability of one or more output modalities based on the connection to the network.

6. The device of claim 1, wherein the output modality comprises one or more of an audible sound, an audible speech, a text message, a graphical message, a video, displayed information, a vibration, an optical signal, activation of a device, or execution of a command.

7. The device of claim 2, wherein the sensor input is configured to receive sensory information from one or more sensors, the one or more sensors comprising a biometric sensor, an inertial sensor, a global positioning system, or a microphone.

8. The device of claim 1, further comprising an automatic speech recognition (ASR) system, the ASR system configured to receive a speech signal representing an audible request for help from the user and translate the speech signal into a text format recognizable by the dialog system.

9. A method for providing information to a user, the method comprising:
receiving, at a user device implemented at least partially in hardware, an indication to provide help to the user;
determining a response to the indication;
identifying one or more output modalities for the response;
identifying one or more available output modalities;
identifying a preferred output modality for the response and from the one or more available output modalities; and
providing the response to the user using the preferred output modality.

10. The method of claim 9, further comprising:
receiving sensory information from one or more sensors identifying a state of the user based on the sensory information.

11. The method of claim 10, wherein the sensory information comprises one or more of biometric information, positioning information, network connectivity information, peripheral device connectivity information, inertial information, or sound information.

12. The method of claim 9, wherein identifying the availability of one or more output modalities comprises identifying a connection to a second device, wherein the second device comprises one or more output modalities absent from the user device.

13. The method of claim 9, further comprising detecting a connection to a network, and identifying the availability of one or more output modalities comprises:
detecting a connection to the network,
identifying a second device connected to the network,
connecting to the second device through the network using an application programming interface,
identifying one or more available output modalities associated with the second device; and
causing the second device to provide the requested information using one or more output.

14. The method of claim 9, wherein the one or more output modalities comprise one or more of an audible sound, an audible speech, a text message, a graphical message, a video, displayed information, a vibration, an optical signal, activation of a device, or execution of a command.

15. The method of claim 14, further comprising receiving sensory information from one or more sensors, the one or more sensors comprising a biometric sensor, an inertial sensor, a global positioning system, or a microphone.

16. A computer program product tangibly embodied on non-transient computer readable media, the computer program product comprising instructions operable when executed to:
receive an indication to provide help to a user;
identify an availability of one or more output modalities for providing the help; and
determine an output modality for providing the help based on the availability of the one or more output modalities;
process the request for help; and
provide a dialog message in response to the request for help, the dialog message provided on the determined output modality.

17. The computer program product of claim 16, the instructions operable to:
receive sensory information from one or more sensors identifying a state of the user based on the sensory information.

18. The computer program product of claim 17, wherein the sensory information comprises one or more of biometric information, positioning information, network connectivity information, peripheral device connectivity information, inertial information, or sound information.

19. The computer program product of claim 16, wherein identifying the availability of one or more output modalities comprises identifying a connection to a second device, wherein the second device comprises one or more output modalities absent from a user device.

20. The computer program product of claim 16, the instructions operable to detect a connection to a network, and identifying the availability of one or more output modalities comprises:
detecting a connection to the network,
identifying a second device connected to the network,
connecting to the second device through the network using an application programming interface,
identifying one or more available output modalities associated with the second device; and
causing the second device to provide the requested information using one or more output.

21. The computer program product of claim 16, the instructions operable to receive sensory information from one or more sensors, the one or more sensors comprising a biometric sensor, an inertial sensor, a global positioning system, or a microphone.

22. A system for providing information to a user, the system comprising:
a memory for storing instructions;
an analysis logic implemented at least partially in hardware to:
receive a request for help from the user;
identify an availability of one or more output modalities for providing the help; and
determine an output modality for providing the help based on the availability of the one or more output modalities;
a dialog system implemented at least partially in hardware to:
process the request for help; and
provide a dialog message in response to the request for help, the dialog message provided on the determined output modality; and
a sensor input for receiving sensory information, wherein the analysis logic identifies the output modality based, at least in part, on the sensory information.

23. The system of claim 22, further comprising an interface to a second device, and wherein the analysis logic identifies the availability of one or more output modalities based on a connection to a second device, wherein the second device comprises one or more output modalities absent from the device.

24. The system of claim 22, further comprising a connection to a network, and wherein the analysis logic identifies the availability of one or more output modalities based on the connection to the network.

25. The system of claim 22, wherein the output modality comprises one or more of an audible sound, an audible speech, a text message, a graphical message, a video, displayed information, a vibration, an optical signal, activation of a device, or execution of a command.
